(19) United States
(12) Patent Application Publication
(10) Pub. No.: US 2024/0305136 A1
(43) Pub. Date: Sep. 12, 2024

(54) POWER TRANSMISSION DEVICE AND NON-CONTACT POWER SUPPLY SYSTEM

(71) Applicant: Mitsubishi Electric Corporation, Tokyo (JP)

(72) Inventor: Takuya NAKANISHI, Tokyo (JP)

(73) Assignee: Mitsubishi Electric Corporation, Tokyo (JP)

(21) Appl. No.: 18/574,751

(22) PCT Filed: Jul. 2, 2021
(86) PCT No.: PCT/JP2021/025120

§ 371 Date: Dec. 28, 2023

(51) Int. Cl. H02J 50/12

(52) U.S. Cl. CPC H02J 50/12

(57) ABSTRACT

A series unit of an inductor and a first capacitor is connected to the AC side of the inverter, a series unit of a second capacitor and the power transmitting coil is connected in parallel to the first capacitor, a controller controls the inverter by switching between two modes that are a power transmission mode in which power is transmitted to the power transmitting coil and a coil detection mode in which a low output period and a zero output period are alternately repeated, and switching of the modes is performed on the basis of a state after mode transition in which information changes at a point in time when a predetermined condition is satisfied after mode switching, and a value of an operation parameter at least related to input power to the inverter.

### TECHNICAL FIELD

The present application relates to a power transmission device and a non-contact power supply system.

### BACKGROUND ART

As a non-contact power supply technique, there is a technique for transmitting power by magnetic field coupling between two coils spaced apart from each other. This non-contact power supply has been studied for an application to power supply to a moving object such as a traveling automobile. The non-contact power supply to the moving object is a system in which the power receiving coil passes right above the power transmitting coil in a short time, and the coupling state between the coils, that is, the electrical state viewed from the power transmitting side, constantly varies. Various techniques have been studied for controlling transmission power when a power receiving coil enters a position right above a power transmitting coil and when a coupling state between coils varies (for example, Non-Patent Document 1).

### PRIOR ART DOCUMENT

### Non-Patent Document

Non-Patent Document 1: Katsuhiro Hata, et. al, “Driving Test Evaluation of Sensorless Vehicle Detection Method for In-motion Wireless Power Transfer”, Proc. The 2018 International Power Electronics Conference, pp 663-668.

### SUMMARY OF INVENTION

### Problems to be Solved by Invention

In the technique described in Non-Patent Document 1, since there is a sequence in which the power transmitting side and the power receiving side cooperate with each other in order, there is a problem in that switching cannot be performed in a time equal to or less than a time for switching between the modes, and an entry detection and an exit detection of the power receiving coil cannot be performed at a high speed. In addition, failure tolerance of the exit detection is low, and if the exit detection of the power receiving coil fails once, a current flows for a considerable time, which causes an increase in noise and an increase in a power loss.

The present application has been made to solve the above-described problems, and an object of the present application is to provide a power transmission device capable of determining the entry and exit of the power receiving coil at high speed only on the power transmitting side, thereby suppressing an increase in the power loss and suppressing noise.

### Means for Solving Problems

A power transmission device disclosed in the present application includes a power transmitting coil to be magnetically coupled to an external power receiving coil to transmit electric power to the power receiving coil, an inverter to supply alternating-current power to the power transmitting coil, and a controller to control the inverter. A series unit of an inductor and a first capacitor is connected to an AC side of the inverter, a series unit of a second capacitor and the power transmitting coil is connected in parallel to the first capacitor. The controller is configured to control the inverter by switching between two modes that are a power transmission mode in which the inverter is operated to transmit power to the power transmitting coil and a coil detection mode in which a low output period in which the inverter is operated with output power lower than rated power and a zero output period in which an output of the inverter is set to zero are alternately repeated, and to execute switching of the modes on a basis of a state after mode transition in which information changes at a point in time when a predetermined condition is satisfied after mode switching, and a value of an operation parameter at least related to input power to the inverter.

### Advantageous Effect of Invention

According to the power transmission device disclosed in the present application, the entry and exit of the power receiving coil can be determined at high speed only on the power transmitting side, an increase in the power loss can be suppressed, and noise can also be suppressed.

### BRIEF DESCRIPTION OF THE DRAWINGS

FIG. 1 is a circuit diagram schematically showing a configuration of a non-contact power supply system including a power transmission device according to Embodiment 1.

FIG. 2 is a schematic diagram showing states of the non-contact power supply system including the power transmission device according to Embodiment 1.

FIG. 3 is a flowchart showing an outline of an operation in a power transmission mode of the power transmission device according to Embodiment 1.

FIG. 4 is a flowchart showing an outline of an operation of a coil detection mode of the power transmission device according to Embodiment 1.

FIG. 5 is a diagram showing a relationship among a state after mode transition, a coil detection mode, and a power transmission mode in the power transmitting device according to Embodiment 1.

FIG. 6A and FIG. 6B are each a diagram showing an incorrect relationship between a state after mode transition and modes.

FIG. 7 is a diagram showing an operation waveform in a low output mode in the coil detection mode of the power transmission device according to Embodiment 1.

FIG. 8 is a flowchart showing an operation of a sequence A in the coil detection mode of the power transmission device according to Embodiment 1.

FIG. 9 is a flowchart showing an operation of a sequence X in the coil detection mode of the power transmission device according to Embodiment 1.

FIG. 10 is a flowchart showing an operation of a sequence B in the power transmission mode of the power transmission device according to Embodiment 1.

FIG. 11 is a flowchart showing an operation of a sequence Y in the power transmission mode of the power transmission device according to Embodiment 1.

FIG. 12 is a first diagram for describing an operation of the power transmission device according to Embodiment 1.

FIG. 13 is a second diagram for describing the operation of the power transmission device according to Embodiment 1.

FIG. 14 is a circuit diagram showing an example of a configuration of the non-contact power supply system.

FIG. 15 is a circuit diagram showing another example of a configuration of the non-contact power supply system.

FIG. 16 is a circuit diagram schematically showing a configuration of a non-contact power supply system including a power transmission device according to Embodiment 2.

FIG. 17 is a diagram for describing an operation of the power transmission device according to Embodiment 2.

FIG. 18 is a block diagram showing an example of a specific configuration of a controller of the power transmission device disclosed in the present application.

### MODE FOR CARRYING OUT INVENTION

### Embodiment 1

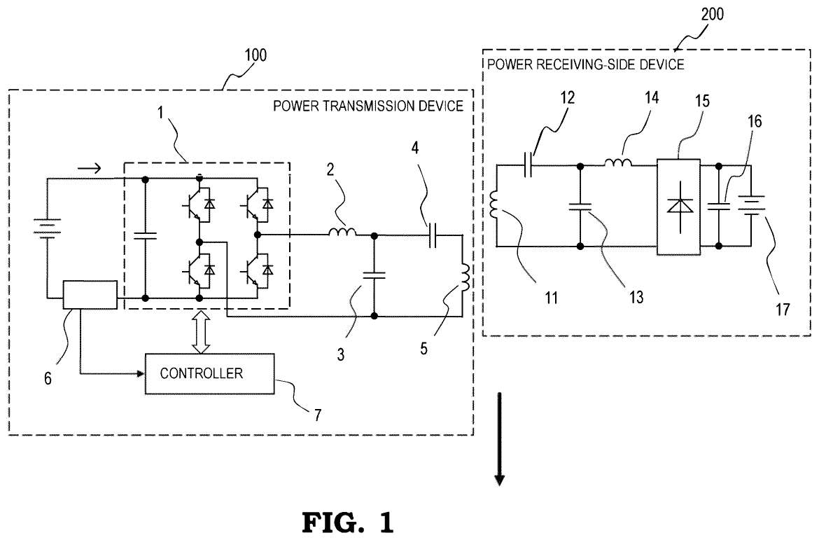

FIG. 1 is a circuit diagram schematically showing a configuration of a non-contact power supply system including a power transmission device according to Embodiment 1. The power transmission device 100 includes an inverter 1 that converts direct current (DC) power into alternating current (AC) power and outputs the AC power, an inductor 2, a first capacitor 3, a second capacitor 4, a power transmitting coil 5, a current sensor 6 that detects an input current of the inverter 1, and a controller 7 that receives information from the current sensor 6 as an input and controls an operation of the inverter.

The components are connected in the following manner. The inductor 2 and the first capacitor 3 are connected in series to an output terminal of the inverter 1. The second capacitor 4 and the power transmitting coil 5 are connected in series, and are connected in parallel to the first capacitor 3.

The inverter 1 is constituted with semiconductor switches. In FIG. 1, the inverter 1 has a full-bridge configuration using four semiconductor switches, but may have a half-bridge configuration or other configurations. The bridge configuration is not particularly limited, and the semiconductor switch may be an insulated gate bipolar transistor (IGBT), a field effect transistor (FET), or the like, and the type of the switch is not particularly limited.

A power receiving-side device 200 includes a power receiving coil 11, a first power receiving-side capacitor 12, a second power receiving-side capacitor 13, a power receiving-side inductor 14, a rectifier 15 that rectifies an alternating current, and a smoothing capacitor 16 that smooths a waveform after the rectification. A load such as a battery 17 is connected to a subsequent stage of the smoothing capacitor 16.

The power receiving coil 11 and the first power receiving-side capacitor 12 are connected in series, the second power receiving-side capacitor 13 is connected in parallel to this series connection unit, the power receiving side inductor 14 is connected to a subsequent stage of the second power receiving-side capacitor 13, and the rectifier 15 and the smoothing capacitor 16 are connected in order to a subsequent stage thereof. The rectifier 15 is constituted with diodes and may be either a half-wave rectifier or a full-wave rectifier as long as it can rectify an alternating current. In the above description, a configuration having a larger effect has been described as the configuration on the power receiving side. The inductor and the capacitor on the power receiving side are not limited to this configuration, and they may be removed or an inductor and a capacitor may be added.

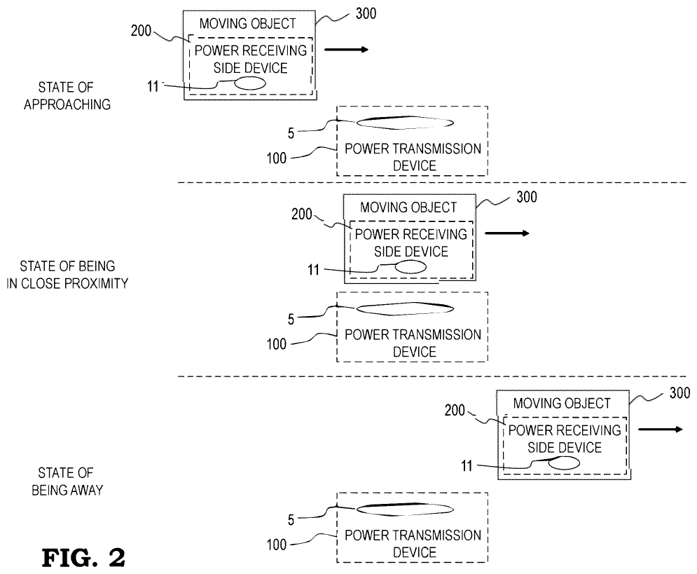

Next, an operation of the non-contact power supply system will be described. For example, the power transmission device 100 is laid on a road, and the power receiving-side device 200 is mounted on a moving object such as an automobile. The road is assumed to be a highway, for example, on which the automobile travels in one direction at a high speed. The above situation is shown in FIG. 2. A moving object 300 on which the power receiving-side device 200 is mounted changes its state from a state of approaching the power transmitting device laid on a road to a state of being in close proximity to the power transmitting device, and then to a state of being away from the power transmitting device 100.

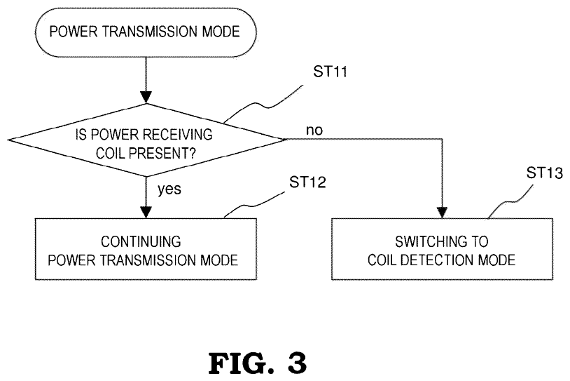

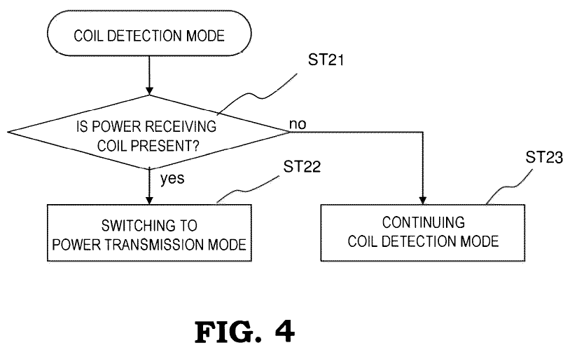

The power transmission device 100 has two operation modes. One is a coil detection mode (hereinafter, also simply referred to as a detection mode) and the other is a power transmission mode (hereinafter, also simply referred to as a transmission mode). The power transmission device 100 operates while switching between the coil detection mode and the power transmission mode. FIG. 3 shows a flowchart of an outline of the operation of the power transmission mode, and FIG. 4 shows a flowchart of an outline of the operation of the coil detection mode.

Referring to FIG. 3 and FIG. 4, an outline of the operation of the power transmission device 100 will be described. During the operation in the power transmission mode, when the power receiving coil is present right above the power transmitting coil (yes in step ST11) and the coupling state between the coils is appropriate, the power transmission mode is continued (step ST12). When the absence of the power receiving coil above the power transmitting coil is detected (no in step ST11), the mode is switched to the coil detection mode (step ST13). When the presence of the power receiving coil is detected in the coil detection mode (yes in ST21), the mode is switched to the power transmission mode (ST22). When the power receiving coil is absent (no in step ST21), the coil detection mode is continued (step ST23). The presence or absence of the power receiving coil is determined by using a value of an operation parameter related to the input power such as an input current or input power to the inverter and the information on a state after mode transition. A phase shift amount may be used for the determination. Details on the state after mode transition will be described later.

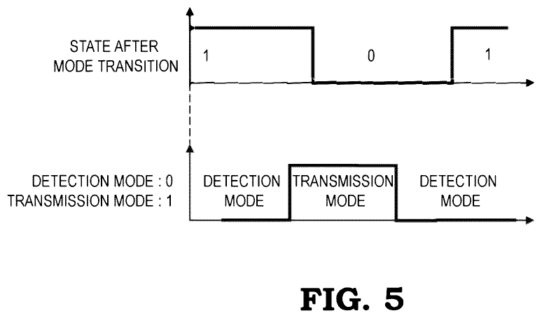

FIG. 5 shows a relationship between the state after mode transition and each mode. The state after mode transition is information that changes at a point in time when a predetermined condition is satisfied, such as an elapsed time after switching between the coil detection mode and the power transmission mode, and is information of a minimum 1 bit having states of 0 and 1. At a point in time when the predetermined condition is satisfied after switching from the coil detection mode to the power transmission mode, the information is changed from 1 to 0, and at a point in time when the predetermined condition is satisfied after the mode switching from the power transmission mode to the coil detection mode, the information is changed from 0 to 1. Details on the predetermined condition will be described later.

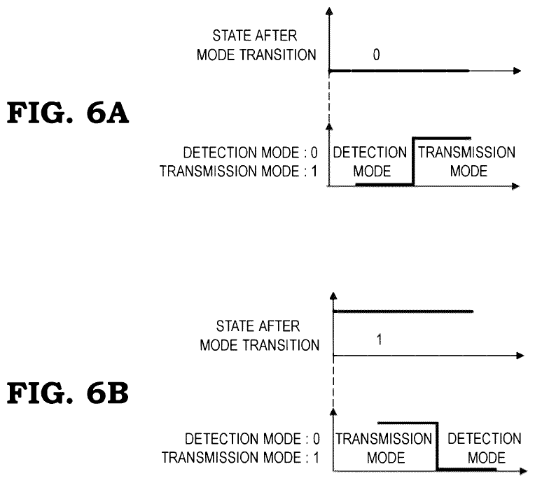

For supplementary description, FIG. 6A and FIG. 6B show an incorrect relationship between the state after mode transition and modes. When the state after mode transition is 0, the mode is not switched from the coil detection mode to the power transmission mode as shown in FIG. 6A. In addition, when the state after mode transition is 1, the mode is not switched from the power transmission mode to the coil detection mode as shown in FIG. 6B. Note that the relationship between 0 and 1 in the state after mode transition may be reversed, and the information of the state after mode transition (normally, a simple signal such as 0 and 1) may be any information as long as it can be determined whether or not the predetermined condition is satisfied after the mode is changed.

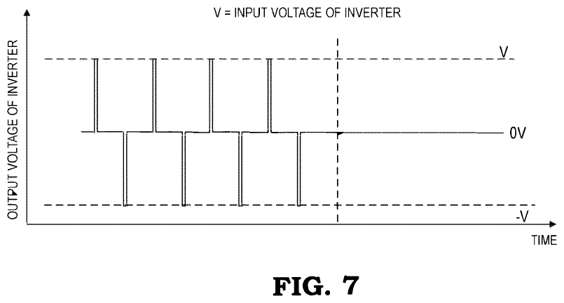

First, details on the coil detection mode will be described. In the coil detection mode, an operation for setting the output of the inverter 1 to 0 (stopping the operation of the inverter) and an operation for performing an output from the inverter 1 are alternately repeated. FIG. 7 shows a waveform of the output voltage of the inverter 1 in the operation for performing the output from the inverter 1. In most cases, the coil detection mode is performed in a state where the power receiving-side device 200, that is, the power receiving coil, is not present. Therefore, when the output from the inverter 1 is performed, the coil detection mode is performed in a state where the output is reduced. This output is not particularly specified, but is set to an output lower than a rated power of the inverter 1, for example, a low output equal to or less than one tenth of the rated power. A period of the operation state of a zero output in the coil detection mode is defined as a zero output period, and a period of the operation state for performing the output is defined as a low output period.

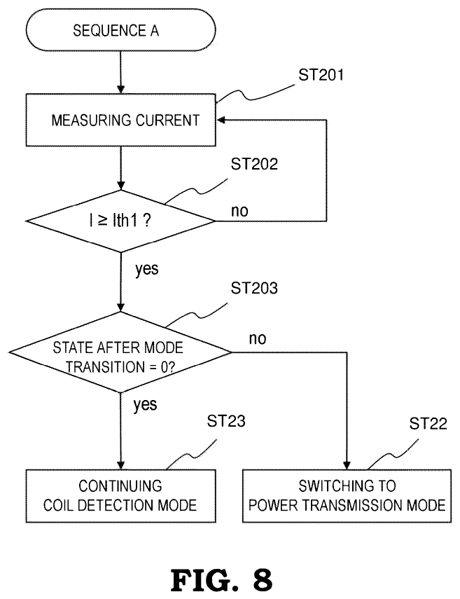

During the operation in the coil detection mode, a sequence A is executed, and a flowchart for the sequence A is shown in FIG. 8. In the sequence A, an input current to the invertor 1 is measured by the current sensor 6 (step ST201), and a sequence for determining whether or not the current value I is equal to or larger than a value Ith1 set as an entry threshold is executed (step ST202). In a case where the current value I is less than the entry threshold (I<Ith1) (no in step ST202), it is determined that the power receiving coil is absent, the process returns to step ST201, and the detection mode is continued. When the input current is equal to or larger than the entry threshold (I≥Ith1) (yes in step ST202), the state after mode transition is determined (step ST203). In the determination of the state after mode transition, when the state after mode transition is 0 (yes in step ST203), it is determined that the power receiving coil is absent, and the coil detection mode is continued (step ST23). In the determination of the state after mode transition, when the state after mode transition is 1 (no in step ST203), it is determined that the power receiving coil is present, and the mode is switched to the power transmission mode (step ST22).

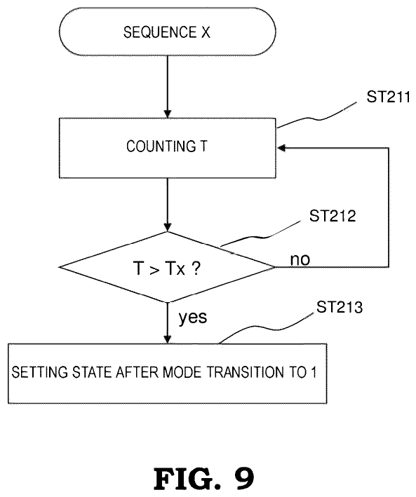

In parallel with the above, a sequence X is executed, and a flowchart of the sequence X is shown in FIG. 9. After switching from the power transmission mode to the coil detection mode, counting of an elapsed time T (step ST211) is started. When the elapsed time T is equal to or less than a determination reference time Tx (no in step ST212), the process returns to step ST211 to further continue counting T, and at a point in time when T becomes larger than Tx (yes in step ST212), the state after mode transition is set to 1 (step ST213). Here, the determination reference time Tx is set as a time ta of one repetition cycle for the zero output period and the low output period of the inverter in the coil detection mode. That is, the above-described predetermined condition after the mode switching, which changes the state after mode transition, is that the time of one repetition cycle for the zero output period and the low output period has elapsed after the mode switching to the coil detection mode. Here, the determination reference time Tx is set as the time ta of one repetition cycle for the zero output period and the low output period of the inverter in the coil detection mode. However, the determination reference time Tx is not necessarily limited to the one cycle, and should be a time equal to or larger than the time ta of one repetition cycle. That is, the above-described predetermined condition after the mode switching is that the time of at least one repetition cycle for the zero output period and the low output period of the inverter in the coil detection mode has elapsed. Note that Tx can be increased to be equal to or larger than the time of one repetition cycle, but the effect becomes smaller as Tx is increased. Therefore, it is desirable that Tx should be ideally equal to or less than two repetition cycles.

Next, the power transmission mode will be described. In the power transmission mode, the power of the power transmission device 100 is controlled so as to be a rated power or a desired power by phase shift control of the inverter or the like. Here, the phase shift control will be described as an example of the power control method. However, the power control method may be a method other than the phase shift control. For example, a voltage input to the previous stage of the inverter may be controlled. In this case, an equivalent effect can be obtained by replacing the phase shift amount with a control amount in the control concerned and performing the control. The control amount in the control concerned is the input voltage of the inverter or a duty ratio of a pulse width modulation (PWM) of a converter that directly controls the input voltage of the inverter. Further, as an example of another control, control in which a normal PWM control is performed for the inverter may be adopted instead of the phase shift control.

In the power control, any control may be used as long as the control tracks the target value. Here, proportional, integral, and differential (PID) control will be described as an example. When switching to the power transmission mode and PID control is performed, a deviation between the input current detected by the current sensor 6 and a target value at the time of power transmission is input to the PID calculation, the phase shift amount is adjusted in accordance with an output of the PID calculation, and control is performed so that the input current can match the target value. The PID control itself is a typical method. Proportional (P) control, proportional and differential (PD) control, or proportional and integral (PI) control may be used.

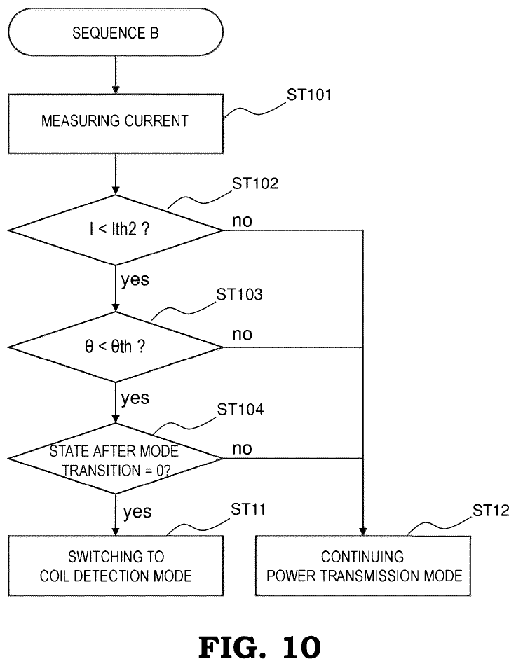

In parallel with the above-described power control, a sequence B is executed. A flowchart for the sequence B is shown in FIG. 10. In the sequence B, the input current value is measured by the current sensor 6 (step ST101), and when it is equal to or larger than an exit threshold Ith2 (no in step ST102), it is determined that the power receiving coil is present, and the power transmission mode is continued (step ST12). When it is less than the exit threshold Ith2 (yes in step ST102), the phase shift amount at that time is determined (step ST103). When the phase shift amount 0 is equal to or larger than an exit threshold 0th that is predetermined (no in step ST103), it is determined that the power receiving coil is present, and the power transmission mode is continued (step ST12). When the phase shift amount is less than 0th (yes in step ST103) and the state after mode transition is 1 (no in step ST104), it is determined that the power receiving coil is present, and the power transmission mode is continued (step ST12). When the phase shift amount is less than 0th (yes in step ST103) and the state after mode transition is 0 (yes in step ST104), it is determined that the power receiving coil is absent or the coupling is reduced to be unsuitable for the power transmission, and the power transmission mode is switched to the coil detection mode (step ST11).

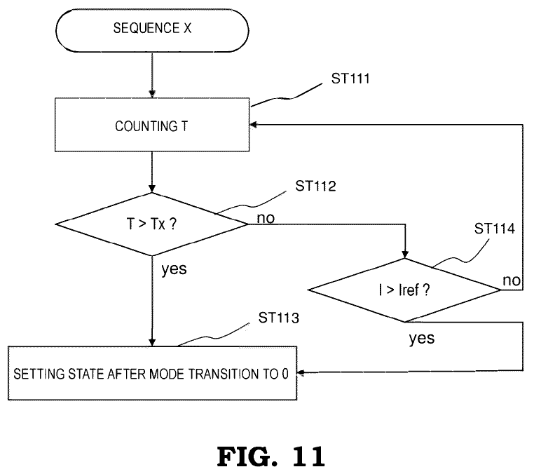

In parallel with the above power control, a sequence Y is executed. A flowchart for the sequence Y is shown in FIG. 11. After switching from the coil detection mode to the power transmission mode, counting of the elapsed time T (step ST111) is started. At a point in time when the elapsed time T becomes larger than Tx (yes in step ST112), the state after mode transition is set to 0 (step ST113). Tx is one repetition cycle ta for the zero output period and the low output period in the coil detection mode or a time equal to or larger than ta. That is, at a point in time when the elapsed time T reaches at least one repetition cycle ta for the zero output period and the low output period in the coil detection mode, the state after mode transition is set to 0. Even when T is equal to or less than Tx (no in step ST112), the state after mode transition is set to 0 (step ST113) at a point in time when the present measured value I (or power) of the input current to the inverter reaches a target value Iref (or a target power value in the case of power) (yes in step ST114). When T is equal to or less than Tx (no in step ST112) and the measured current I is equal to or less than the target value (no in step ST114), the process returns to step ST111 and the counting of the elapsed time is continued. That is, the point in time when the predetermined condition after the above-described mode switching, at which the state after mode transition is changed, is satisfied is either the point in time when the time of at least one repetition cycle for the low output period and the zero output period in the coil detection mode has elapsed after switching to the power transmission mode, or the point in time when the input current or the input power to the inverter exceeds the predetermined threshold, whichever is earlier.

Here, for example, when Tx is a small value and it is not assumed that the present measured value I of the input current to the inverter reaches the target value Iref at a point in time earlier than Tx after switching from the coil detection mode to the power transmission mode, step ST114 may be omitted, and in the case of no in step ST112, the process may return to step ST111 without passing through ST114. In this case, the above-described predetermined condition after the mode switching is that the time of at least one repetition cycle for the low output period and the zero output period in the coil detection mode has elapsed after the mode switching to the power transmission mode.

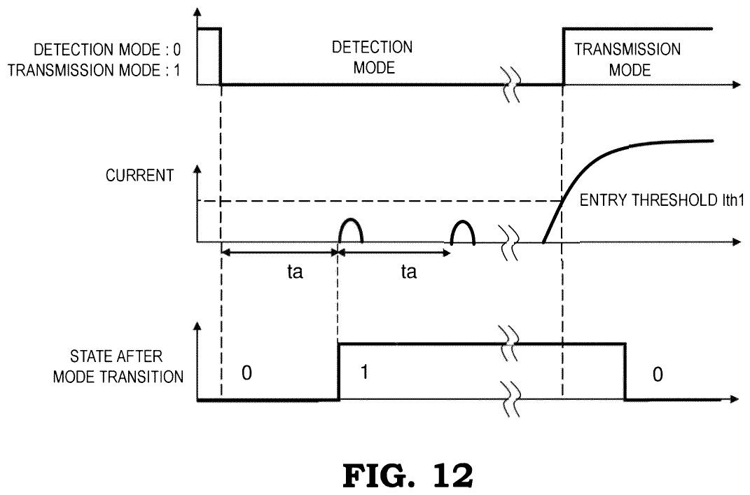

A relationship between each mode, a current waveform, and a state after mode transition at the time of transition from the coil detection mode to the power transmission mode is shown in FIG. 12. The middle stage of FIG. 12 shows a current waveform. In the coil detection mode, the current repeats an output and a non-output at constant intervals. This one cycle is set to ta. When the power receiving coil 11 approaches the power transmitting coil 5, the current increases as compared with the case where the power receiving coil 11 is present. When this exceeds the entry threshold Ith1 and the state after mode transition is 1, the mode is switched to the power transmission mode.

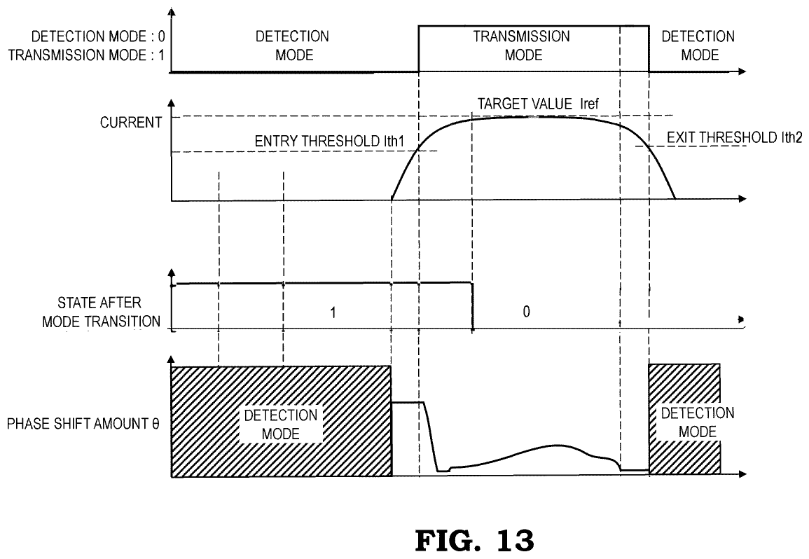

FIG. 13 shows a relationship between each mode, a current waveform, a state after mode transition, and a phase shift amount at the time of transition from the power transmission mode to the coil detection mode. The second stage of FIG. 13 shows the current waveform, and the fourth stage shows the phase shift amount. In the power transmission mode, when the power receiving coil 11 moves away from the power transmitting coil 5, the phase shift amount decreases. That is, the output voltage of the inverter required to output the current increases. When the power receiving coil 11 further moves away therefrom, the current decreases even if the phase shift amount of the inverter is minimized (the inverter output voltage is maximized). When the current value reaches the exit threshold Ith2 and the state after mode transition is 0, the mode is switched to the coil detection mode.

An action and an effect in the circuit of the power transmission device 100 according to Embodiment 1. will be described below. When the power transmitting coil and the power receiving coil are in a magnetically coupled state, the power can be transmitted from the power transmission device 100 to the power receiving-side device 200 with high efficiency. When power is supplied to a moving object as assumed in the present application, the coupling state changes from moment to moment. As the moving object moves, the coupling state between the power transmitting coil and the power receiving coil changes from a low state to a high state, and from the high state to the low state. This corresponds to a situation in which the automobile enters above the power transmitting coil on a road, passes right above the power transmitting coil, and further exits from the power transmitting coil.

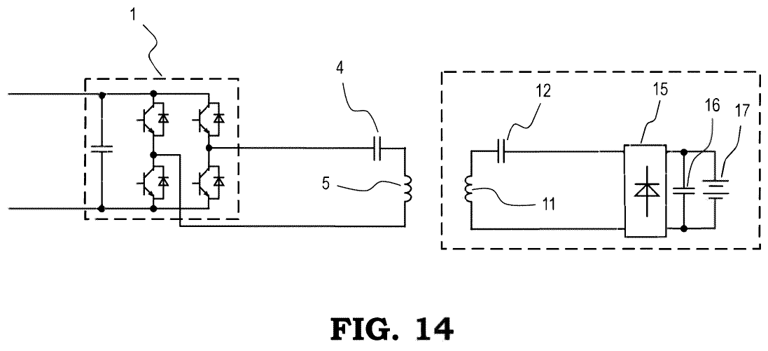

At this time, when the moving object exits, that is, when the coupling between the power transmitting coil and the power receiving coil decreases, the fluctuation of the impedance viewed from the inverter of the power transmitting device greatly differs depending on a resonance configuration of the non-contact power supply system including the power receiving-side device. FIG. 14 shows the non-contact power supply system in a series resonance configuration. In the series resonance configuration in which the power transmitting coil 5 and the second capacitor 4 are connected in series on the power transmitting side and the power receiving coil 11 and the first power receiving-side capacitor 12 are connected in series on the power receiving side, which is often used in the non-contact power supply, the impedance decreases when the coupling between the coils decreases. In contrast, the characteristic is such that, as the coupling between the coils increases, the impedance increases. That is, the current increases when the power receiving coil is absent, and the current decreases when the coil is present. When the presence of the power receiving coil is to be detected on the basis of this characteristic, a method is used in which a power transmitting coil current is measured, and it is determined that the power receiving coil is absent when the power transmitting coil current is equal to or larger than a fixed value, and it is determined that the power receiving coil is present when the power transmitting coil current is equal to or less than the fixed value. However, since the current flows through the power transmitting coil even at the time of normal power transmission, it is difficult to clarify the difference between the current value at the time of power transmission and the current value when the coil is absent. For example, when the current at the time of normal power transmission is 10 A, it is necessary to make a determination based on whether a current threshold at the time of coil detection is larger than 10 A. This causes unnecessary electromagnetic field radiation and a power loss.

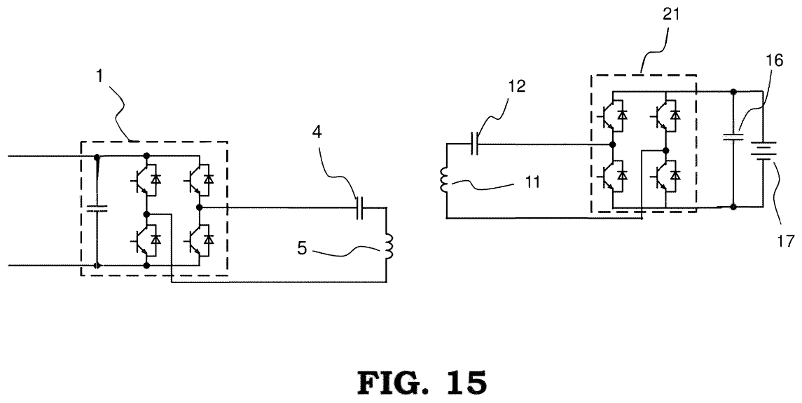

In addition, there is a method for detecting a power receiving coil using a characteristic in which the impedance increases by mounting a converter on the power receiving side and setting the power receiving side in a short-circuited state. An example of such a configuration is shown in FIG. 15. By using this method, it is possible to set the current threshold at the time of determination of coupling between coils to a small value, and it is possible to reduce the unnecessary electromagnetic field radiation and the power loss. That is, the current for the entry detection of the power receiving coil can be set independently of the current value of the power transmission. For example, both low sides of a converter 21 on the power receiving side are turned on to be in a short-circuited state, thereby detecting the power receiving side. After the power receiving side is detected, on the power receiving side, the operation of the converter 21 is returned from the short-circuit state to the normal power transmission mode. Thereafter, it is necessary to operate the power transmission device at an output for performing the normal power transmission, and it takes time from the detection to the rated power transmission. Further, in the configuration of FIG. 15, if the exit detection of the power receiving coil fails, there is a problem in that the power continues to be output even though the coil is absent.

Since the determination by the threshold is made through the increase in the current, if an increase in the current value after the power receiving coil is away is once missed for some reason (for example, instantaneous noise, processing of another event, or the like), it is difficult to determine whether the power transmission is performed, or unnecessary transmission is performed in the absence state of the power receiving coil. This is because the system has a mode suitable for the entry detection but does not have a mode suitable for the exit detection. Ideally, by matching the resonance configuration of the non-contact power supply system with the resonance frequency of the inverter, the current is maximized when the power receiving coil is absent, and thus it is possible to prevent the exit detection from failing. However, in an actual operation, the resonance frequency in the presence of the power receiving coil is normally different from the resonance frequency in the absence of the normal power receiving coil, and it is necessary that the operation frequency of the inverter is shifted to some extent. With this condition, the current does not become maximum when the power receiving coil is completely absent, which makes it difficult to determine the exit. As the coupling between the coils decreases, there are a region where the current increases and a region where the current decreases.

When a resonance configuration in which a parallel capacitor and a series inductor are added to the series resonance configuration, which is the configuration of Embodiment 1, is used, the following characteristics are exhibited.
The impedance increases as the coupling between the coils decreases.
The impedance decreases as the coupling between the coils increases.

Therefore, it is possible to adopt a determination method in which the power receiving coil is present when the current is equal to or larger than a fixed value, and the power receiving coil is absent when the current is equal to or smaller than the fixed value. Therefore, it is possible to reduce the current when the power receiving coil is absent, and it is possible to suppress the unnecessary electromagnetic field radiation and the power loss. However, when only the configuration of the resonance system and the current threshold are used, the coil detection of the target in a stopped state will be successful, but the non-contact power supply to the moving object will not be successful. This is because the following cases cannot be distinguished in the detection of the state.

At a point in time when the receiving coil start entering, in a state in which the current value is started to increase toward the target value in the power transmission mode, the current value is small and the amount of phase shift is small. On the other hand, just before the exit of the power receiving coil, there is a state where the current value is smaller than the target value even when the operation amount is the maximum (the phase shift amount is the minimum) in the power transmission mode. These two states cannot be distinguished only by the current threshold, and cannot be distinguished even by using the phase shift amount. This causes problems such as the switching to the coil detection mode on the determination that the power receiving coil is absent even though the power receiving coil has started entering, and the operating in the power transmission mode for a while even though the power receiving coil has exited. Or, there is a problem in that the power transmission mode and the coil detection mode are frequently switched, and appropriate power transmission and its stop cannot be performed.

If the current threshold in the coil detection mode is set to be large and the current threshold when the exit determination of the power receiving coil is performed in the power transmission mode is set to be a very small value, the above-described problems can be solved to some extent. However, this shortens the time available for the power transmission and increases the unnecessary power transmission, the electromagnetic field radiation, and the power loss, after the exit of the power receiving coil. Ideally, at a point in time when the coil coupling state in which proper power transmission is possible is reached, the mode is quickly switched to the power transmission mode; that is, a current value as small as possible is used as the threshold for switching from the coil detection mode to the power transmission mode, and at a point in time when the coil coupling state in which proper power transmission is impossible is reached, the power transmission mode is quickly switched to the coil detection mode; that is, a current value as large as possible is used as the threshold, so that the power transmission is maximized and the unnecessary electromagnetic field radiation can be minimized.

In Embodiment 1, by adding the information of the state after mode transition in addition to the current threshold, as described above, an effect that the threshold at the time of the detection of the power receiving coil in the coil detection mode can be made small and the current value at the time of the exit determination of the power receiving coil in the power transmission mode can be made large. Since whether the entry transition period or the exit transition period can be determined on the basis of the state after mode transition, it is possible to clearly distinguish the state after mode transition, so that more time can be used for the power transmission, and the unnecessary power loss can be further reduced.

In addition, since the information on the state after mode transition is the minimum 1 bit, the load on the control device is low, the determination is not complicated, and it is not necessary to store a large number of determination parameters for determining the presence or absence of the power receiving coil in the memory for each of assumed situations.

The present application is characterized in that the upper limit and the lower limit of the current threshold can be set to more ideal value. The specific setting of the current threshold depends on the system to be applied to. The present application does not restrict the current threshold, and is characterized in that various problems related to the setting restriction of the threshold, such as the unnecessary radiation and the decrease in the time available for the power transmission, are solved by using the information of the state after mode transition. Note that, although the input current of the inverter has been described as an example of a parameter for determining the mode switching, the input power of the inverter may be used as a parameter for the determination. In this case, in the above description, the input current should be replaced with the input power, and the current should be replaced with the power. In addition, another operation parameter related to the input power of the inverter can be used as a parameter for the determination.

### Embodiment 2

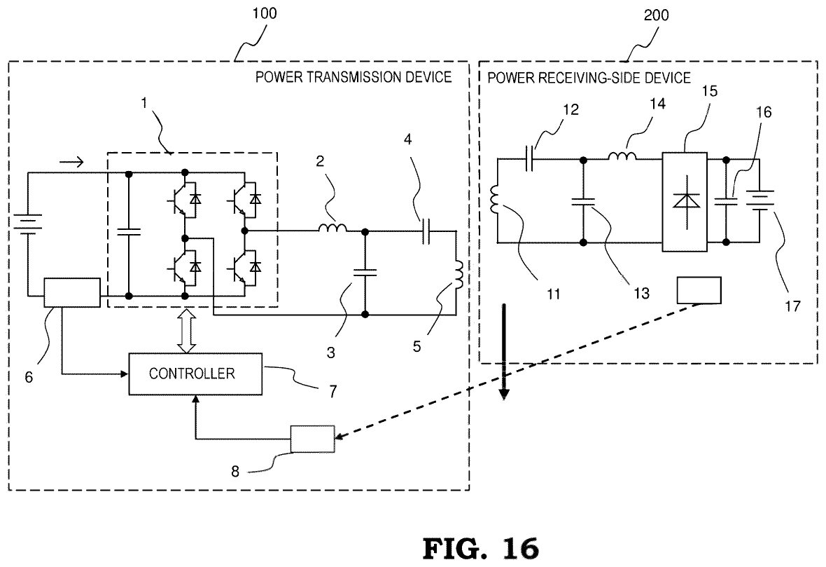

FIG. 16 is a configuration diagram schematically showing a configuration of a non-contact power supply system including a power transmission device according to Embodiment 2. A basic configuration of the power transmission device in the present embodiment will be described. In addition to the configuration described in Embodiment 1, a moving object proximity information sensor 8 is provided for detecting that a moving object approaches closer than a preset distance, and the moving object proximity information sensor 8 is connected to the controller 7.

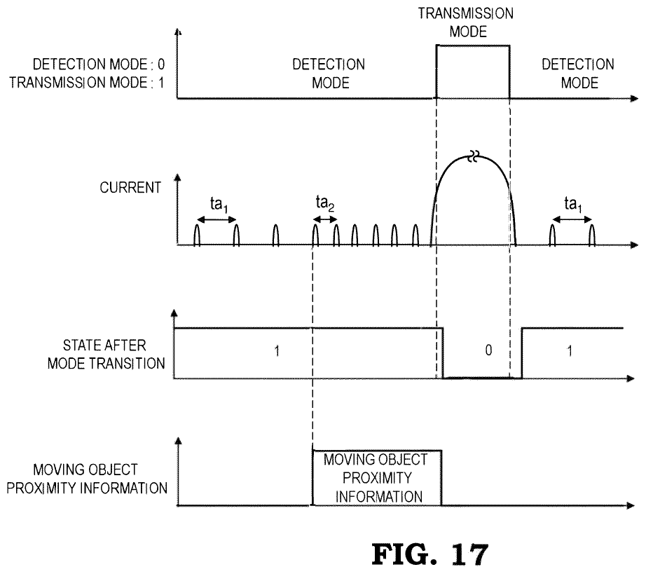

The moving object proximity information sensor 8 transmits moving object proximity information to the controller 7 when the moving object approaches. Note that it does not matter what method is used for sensing the moving object proximity information. In addition, the moving object proximity information may be transmitted to the controller 7 by using moving object proximity information by another device that is mounted. When the moving object proximity information is sent to the controller 7, an operation shown in FIG. 17 is performed. One repetition cycle for the low output period and the zero output period in the detection mode is set as ta₁ when no moving object proximity information is available, and a cycle ta₂ is set to be shorter than ta₁ when the moving object proximity information is available. In this case, the determination reference time Tx in FIG. 9 and FIG. 11 should be based on, for example, the cycle ta₂ that is short. That is, the determination reference time Tx should be a time equal to or larger than ta₂. Further, since the vehicle proximity information is information necessary only in the coil detection mode, the vehicle proximity information is turned off after switching to the power transmission mode.

With such a configuration and the operation, it is possible to minimize unnecessary power radiation and the power loss when the moving object is absent. In addition, when a moving object is in proximity, it is possible to switch from the coil detection mode to the power transmission mode in a short time, and there is an effect in that more power can be transmitted.

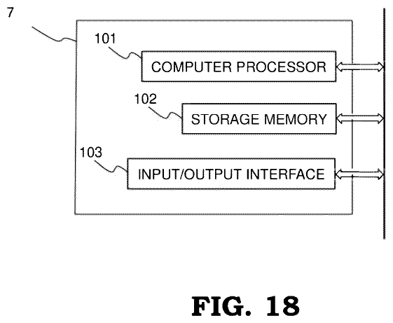

Specifically, as shown in FIG. 18, the controller 7 in each of the above-described embodiments includes a computer processor 101 such as a central processing unit (CPU), a storage memory 102 that exchanges data with the computer processor 101, an input/output interface 103 that inputs and outputs signals between the computer processor 101 and the outside, and the like. As the computer processor 101, an application specific integrated circuit (ASIC), an integrated circuit (IC), a digital signal processor (DSP), a field programmable gate array (FPGA), various signal processing circuits, and the like may be provided. As the storage memory 102, a random access memory (RAM) configured to be able to read and write data from the computer processor 101, a read only memory (ROM) configured to be able to read data from the computer processor 101, and the like are provided. The input/output interface 103 includes, for example, an A/D converter that inputs a signal output from the current sensor 6 to the computer processor 101, a circuit for outputting a signal from the computer processor 101 to the inverter 1, and the like.

Although various exemplary embodiments and examples are described in the present application, various features, aspects, and functions described in one or more embodiments are not inherent in a particular embodiment, and can be applicable alone or in their various combinations to each embodiment. Accordingly, countless variations that are not illustrated are envisaged within the scope of the art disclosed herein. For example, the case where at least one component is modified, added or omitted, and the case where at least one component is extracted and combined with a component in another embodiment are included.

### DESCRIPTION OF REFERENCE NUMERALS AND SIGNS

1: inverter, 2: inductor, 3: first capacitor, 4: second capacitor, 5: power transmitting coil, 6: current sensor, 7: controller, 8: moving object proximity information sensor, 11: power receiving coil, 12: first power receiving-side capacitor, 13: second power receiving-side capacitor, 14: power receiving-side inductor, 15: rectifier, 100: power transmission device, 200: power receiving-side device, 300: moving object

1. A power transmission device comprising:
a power transmitting coil to be magnetically coupled to an external power receiving coil to transmit electric power to the power receiving coil;
an inverter to convert a direct current into an alternating current (AC) to supply AC power to the power transmitting coil; and
a controller to control the inverter, wherein
a series unit of an inductor and a first capacitor is connected to an AC side of the inverter, a series unit of a second capacitor and the power transmitting coil is connected in parallel to the first capacitor,
the controller is configured to control the inverter by switching between two modes that are a power transmission mode in which the inverter is operated to transmit power to the power transmitting coil and a coil detection mode in which a low output period in which the inverter is operated with output power lower than rated power and a zero output period in which an output of the inverter is set to zero are alternately repeated, and
to execute switching of the modes on a basis of a state after mode transition in which information changes at a point in time when a predetermined condition is satisfied after mode switching, and a value of an operation parameter at least related to input power to the inverter.

2. The power transmission device according to claim 1, wherein the predetermined condition in a case where the power transmission mode is switched to the coil detection mode is that a time of at least one repetition cycle for the low output period and the zero output period has elapsed after the power transmission mode is switched to the coil detection mode.

3. The power transmission device according to claim 1, wherein the predetermined condition in a case where the coil detection mode is switched to the power transmission mode is that a time of at least one repetition cycle for the low output period and the zero output period has elapsed after the power transmission mode is switched to the coil detection mode.

4. The power transmission device according to claim 1, wherein a point in time at which the predetermined condition is satisfied in a case where the coil detection mode is switched to the power transmission mode is either a point in time at which the time of at least one repetition cycle for the low output period and the zero output period in the coil detection mode has elapsed after the coil detection mode is switched to the power transmission mode, or a point in time at which an input current or input power to the inverter exceeds a predetermined threshold, whichever is earlier.

5. The power transmission device according to claim 1, wherein the controller executes switching from the coil detection mode to the power transmission mode when information on the state after mode transition is information after a change after switching from the power transmission mode to the coil detection mode and the input current or the input power to the inverter exceeds a predetermined entry threshold.

6. The power transmission device according to claim 1, wherein
the inverter is an inverter based on phase shift control for controlling an output by changing a phase shift amount, and
the controller executes switching from the power transmission mode to the coil detection mode when information on the state after mode transition is information after a change after switching from the coil detection mode to the power transmission mode, and the input current or the input power to the inverter is less than a predetermined first exit threshold and the phase shift amount is less than a predetermined second exit threshold.

7. The power transmission device according to claim 1, wherein
the controller is configured to receive moving object proximity information indicating that a moving object has approached closer than a preset distance, and
when the moving object proximity information is received, a repetition cycle for the low output period and the zero output period is set to be shorter than the repetition cycle before the moving object proximity information is received.

8. A non-contact power supply system comprising:
the power transmission device according to claim 1; and
a power receiving-side device in which a series unit of a power receiving-side inductor and a second power receiving-side capacitor is connected to an AC side of a rectifier, and a first power receiving-side capacitor and the power receiving coil are connected in parallel with the second power receiving-side capacitor, and which is mounted on a moving object.

9. The power transmission device according to claim 2, wherein the predetermined condition in a case where the coil detection mode is switched to the power transmission mode is that a time of at least one repetition cycle for the low output period and the zero output period has elapsed after the power transmission mode is switched to the coil detection mode.

10. The power transmission device according to claim 2, wherein a point in time at which the predetermined condition is satisfied in a case where the coil detection mode is switched to the power transmission mode is either a point in time at which the time of at least one repetition cycle for the low output period and the zero output period in the coil detection mode has elapsed after the coil detection mode is switched to the power transmission mode, or a point in time at which an input current or input power to the inverter exceeds a predetermined threshold, whichever is earlier.
